(19) United States
(12) Patent Application Publication
(10) Pub. No.: US 2025/0358377 A1
(43) Pub. Date: Nov. 20, 2025

(54) IMAGE RECORDING APPARATUS

(71) Applicant: SEIKO EPSON CORPORATION, Tokyo (JP)

(72) Inventors: Satoshi NAKATA, MATSUMOTO-SHI (JP); Katsumi YAMADA, MATSUMOTO-SHI (JP); Kanji MOMOSE, MATSUMOTO-SHI (JP); Masahito TATSUMI, SHIOJIRI-SHI (JP)

(21) Appl. No.: 19/205,281

(22) Filed: May 12, 2025

(30) Foreign Application Priority Data
May 14, 2024 (JP) 2024-078482

(51) Int. Cl. H04N 1/00; H04N 1/028

(52) U.S. Cl. CPC H04N 1/00554; H04N 1/00602; H04N 1/00628; H04N 1/02815; H04N 2201/0094

(57) ABSTRACT

An image recording apparatus includes a recording unit configured to record an image on a medium; a body apparatus configured to house the recording unit; a document reader disposed in an upper portion of the body apparatus and having a placement surface of a document placement table at which a document is placed; a document cover a state thereof is allowed to be switched between a closed state in which the document cover covers the placement surface from above and an open state in which the document cover is opened to expose a space above the placement surface; and a holding mechanism configured to hold the document cover in such a way that a spacing between the placement surface and the document cover in the open state is greater than or equal to 3 cm but smaller than or equal to 10 cm.

The present application is based on, and claims priority from JP Application Serial Number 2024-078482, filed May 14, 2024, the disclosure of which is hereby incorporated by reference herein in its entirety.

### BACKGROUND

### 1. Technical Field

The present disclosure relates to an image recording apparatus.

### 2. Related Art

There is a known related-art apparatus in which in preparation for reading a document, a pressure plate as a document cover is largely opened so that a document table glass plate as a placement surface of a document placement table is exposed, the document is placed, and then the pressure plate is closed, as disclosed in JP-A-2023-167889.

JP-A-2023-167889 is an example of the related art.

However, the apparatus described above has a configuration in which it is not necessary to hold the pressure plate at a small angle with respect to the document table glass plate, and therefore has poor usability in placing a document when the apparatus is installed at a location where the space above the apparatus is limited.

### SUMMARY

An image recording apparatus includes a recording unit configured to record an image on a medium; a body apparatus configured to house the recording unit; a document reader disposed in an upper portion of the body apparatus and having a placement surface of a document placement table at which a document is placed; a document cover a state thereof is allowed to be switched between a closed state in which the document cover covers the placement surface from above and an open state in which the document cover is opened to expose a space above the placement surface; and a holding mechanism configured to hold the document cover in such a way that a spacing between the placement surface and the document cover in the open state is greater than or equal to 3 cm but smaller than or equal to 10 cm.

### BRIEF DESCRIPTION OF THE DRAWINGS

FIG. 1 is a perspective view of an image recording apparatus with a document reading unit located at a closed position.

FIG. 2 is a cross-sectional view of the image recording apparatus with the document reading unit located at the closed position.

FIG. 3 is a diagrammatic view showing a holding mechanism according to a first embodiment in a state in which the document reading unit is located at first and second positions.

FIG. 4 is a diagrammatic view showing a holding mechanism according to a second embodiment in a state in which the document reading unit is located at a first position.

FIG. 5 is a diagrammatic view showing a holding mechanism according to a third embodiment in a state in which the document reading unit is located at a first position.

FIG. 6 is a diagrammatic view showing a holding mechanism according to a fourth embodiment in a state in which the document reading unit is located at a closed position.

FIG. 7 is a diagrammatic view showing the holding mechanism according to the fourth embodiment in a state in which the document reading unit is located at a first position.

FIG. 8 is a diagrammatic view showing the holding mechanism according to the fourth embodiment in a state in which the document reading unit is located at a second position.

### DESCRIPTION OF EMBODIMENTS

An image recording apparatus 1 will be described with reference to the drawings. Note that the directions in the drawing are described with the aid of a three-dimensional coordinate system. For convenience of the description, a positive direction of a Z-axis is referred to as an upward direction, an upper side, or simply referred to as upper, a negative direction of the Z-axis is referred to as a downward direction, a lower side, or simply referred to as lower, a positive direction of an X-axis is referred to as a rightward direction, a right side, or simply referred to as right, a negative direction of the X-axis is referred to as a leftward direction, a left side, or simply referred to as left, a positive direction of a Y-axis is referred to as a forward direction, a front side, or simply referred to as front, and a negative direction of the Y-axis is referred to as a rearward direction, a rear side, or simply referred to as rear.

### 1. Configuration of Image Recording Apparatus

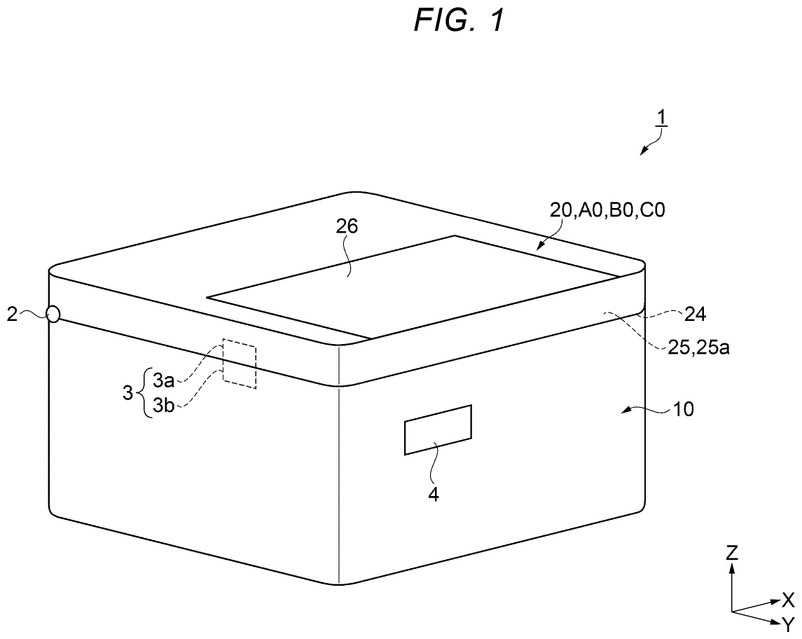

The image recording apparatus 1 includes a document reading unit 20 disposed on the upper side and a body apparatus 10 disposed on the lower side, as shown in FIG. 1. The image recording apparatus 1 is also referred to as an image forming apparatus or a multifunction machine.

The document reading unit 20 is attached in an openable and closable manner to the body apparatus 10 via a hinge 2, which is a portion of the body apparatus 10. The hinge 2 pivotably links the rear or far-side end of a document placement table 25 of the body apparatus 10 to the rear end of a document cover 24 of the document reading unit 20.

Note that the document reading unit 20 may be configured with the document cover 24, as will be described later.

A securing unit 3 includes, for example, a securing latch 3a provided as a portion of the document reading unit 20, and a securing hole 3b provided as a portion of the body apparatus 10.

When an operator closes the document reading unit 20, the securing latch 3a of the securing unit 3 is fitted into the securing hole 3b to secure the document reading unit 20 to the body apparatus 10.

Positions at which the document reading unit 20 is closed are referred to as closed positions A0, B0, and C0, as will be described later. When the document reading unit 20 is closed at the closed position A0, B0, or C0, the document cover 24 of the document reading unit 20 covers a placement surface 25a of the document placement table 25 from above, as will be described later. At this point in time, a second reader 22 of the body apparatus 10 can read a document M on the placement surface 25a, as will be described later.

When the operator presses a button (not shown) for moving the securing latch 3a, the securing latch 3a disengages from the securing hole 3b, and the secured state is released. The operator can then open the document reading unit 20.

Note that the securing unit 3 may be so configured that the securing latch 3a is disposed in the body apparatus 10, and the securing hole 3b is disposed in the document reading unit 20. Instead, the securing unit 3 may be configured with another securing mechanism capable of creating the secured state and the unsecured state.

The document reading unit 20 includes a document support table 26, which supports the document M, as will be described later. The body apparatus 10 includes an input/output unit 4.

The input/output unit 4 is configured, for example, with a touch panel display or buttons. The input/output unit 4 can output a menu relating to the document reading unit 20 and the body apparatus 10, and can receive as input the operator's operation relating to the document reading unit 20 and the body apparatus 10. The operator can operate the input/output unit 4 to instruct the image recording apparatus 1 to read the document M and record the result of the reading on a medium P, as will be described later.

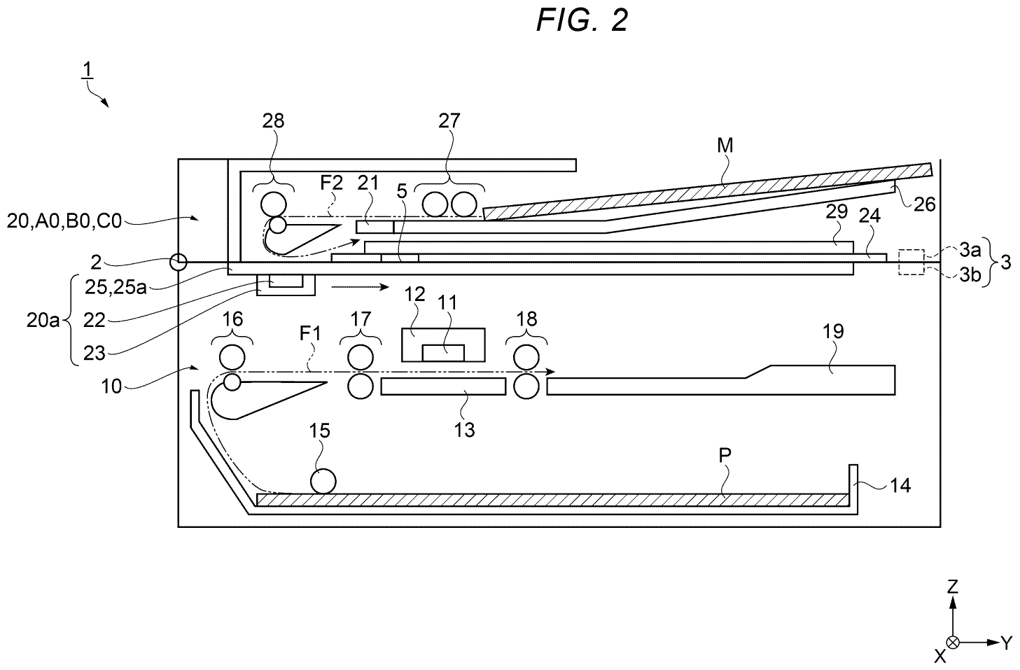

The document reading unit 20 of the image recording apparatus 1 includes a first reader 21 and can function as a sheet feed scanner, as shown in FIG. 2. The sheet feed scanner is also referred to as an automatic document feeder (ADF) scanner. Note that the sheet feed scanner may have a configuration without the first reader 21.

Further, the image recording apparatus 1 includes a document reader 20a in the body apparatus 10, and can also function as a flatbed scanner.

Note that the image recording apparatus 1 may have a configuration having the function of a flatbed scanner but not having the function of a sheet feed scanner. In this case, the document reading unit 20 is configured with the document cover 24, but does not include the first reader 21, document transporting rollers 28, or other portions that realize the function of a sheet feed scanner. That is, the document reading unit 20 is configured with the document cover 24. In this configuration, it is assumed in the above description and the following description that the document reading unit 20 is replaced with the document cover 24.

The document reading unit 20 includes the document support table 26, which supports the document M, separation rollers 27, which separate the document M on the document support table 26, the document transporting rollers 28, which transport the document M along a document transportation direction F2, the first reader 21, which reads the document M, a document discharge tray 29, in which the discharged document M is placed, and the document cover 24.

The document reader 20a is disposed in an upper portion of the body apparatus 10. The document reader 20a includes the document placement table 25 having the placement surface 25a, on which the document M can be placed from above, the second reader 22, which reads the document M from below via the placement surface 25a, and a mover 23, which can move the second reader 22. The placement surface 25a is made, for example, of light transmissive glass.

The first reader 21 as a portion of the document reading unit 20 and the second reader 22 as a portion of the body apparatus 10 are each configured, for example, with a contact image sensor module (CISM). The two readers may instead be each configured with a charge coupled device (CCD) sensor. The first reader 21 and the second reader 22 each also include an LED (not shown) that irradiates a document with light while reading the document.

When the image recording apparatus 1 is used as a sheet feed scanner, the operator sets the document M on the document support table 26 of the document reading unit 20 and operates the input/output unit 4. In the document reading unit 20, the separation rollers 27 separate the document M from other documents M on the document support table 26, and the document transporting rollers 28 transport the document M along the document transport direction F2 with the direction of the document M changed.

The document reading unit 20 reads the rear surface of the document M being transported, which is one surface thereof, with the first reader 21 and discharges the document M into the document discharge tray 29.

At this point in time, the second reader 22 of the document reader 20a as a portion of the body apparatus 10 can read the front surface of the document M, which is the other surface, passing along the placement surface 25a of the document placement table 25 from below via the placement surface 25a.

Note in this case that the mover 23 does not move the second reader 22. The second reader 22 located at a fixed position reads the document M being transported by the document transporting rollers 28.

When the image recording apparatus 1 is used as a flatbed scanner, the operator opens the document reading unit 20, places the document M on the document placement table 25 of the document reader 20a, closes the document reading unit 20, and operates the input/output unit 4. The securing unit 3 secures the document reading unit 20, and the document reading unit 20 is located at the closed position A0, B0, or C0. The document M placed on the document placement table 25 is covered from above with the document cover 24 of the document reading unit 20.

The second reader 22 can read the document M from below via the placement surface 25a while being moved forward or rearward by the mover 23.

As described above, in response to opening and closing the document reading unit 20, the state of the document cover 24 of the document reading unit 20 can be switched between an open state in which the upper side of the placement surface 25a of the document placement table 25 of the document reader 20a is exposed and a closed state in which the placement surface 25a is covered from above.

Note that the document cover 24 is provided with an illuminator 5, which can illuminate the placement surface 25a, as will be described later. Cables such as flexible flat cables (FFCs) and flexible printed circuits (FPCs), which are both flexible, are used for wiring between the body apparatus 10 and the document reading unit 20.

The image recording apparatus 1 can function as an apparatus in which a recording unit 11 housed in the body apparatus 10 records an image on a medium. The recording unit 11 is configured, for example, with an inkjet head.

The recording operation performed by the recording unit 11 is started based on the operator's operation of the input/output unit 4 or acquisition of data. The medium P housed in a sheet feed tray 14 is fed one by one by a sheet feeding roller 15, and is transported to the recording unit 11 by medium transporting rollers 16 and 17 along a medium transportation direction F1 with the direction of the medium P changed. The recording unit 11 and a platen 13 are disposed so as to face each other.

The transported medium P reaches the position between the recording unit 11 and the platen 13. The recording unit 11 performs recording on the medium P by ejecting ink from above while being moved rightward and leftward by a carriage 12. The recorded medium P is transported by medium discharging rollers 18 and is discharged into a medium discharge tray 19.

The image recording apparatus 1 can be so configured that the front and rear surfaces of the medium P are swapped, for example, by the medium transporting rollers 16 and 17. The recording unit 11 can also perform recording on both the front and rear surfaces of the medium P.

A holding mechanism of the document reading unit 20 according to each of first to fourth embodiments will be described below. It is assumed as described above that when the image recording apparatus 1 does not have the function of a sheet feed scanner, the document reading unit 20 does not include the first reader 21 or the like, and in the following description, the document reading unit 20 is replaced with the document cover 24.

### 2. Holding Mechanism According to First Embodiment

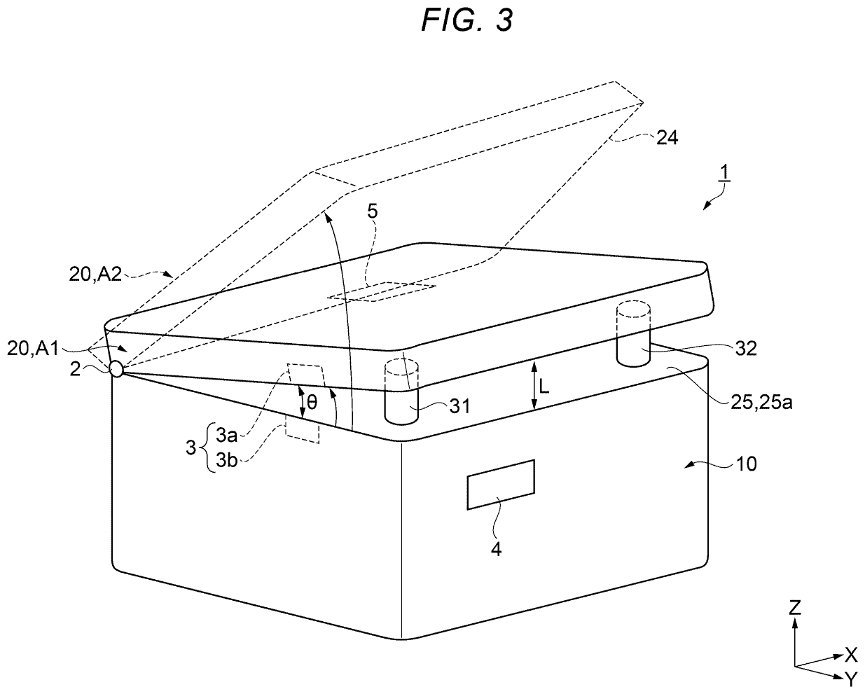

FIG. 3 shows dampers 31 and 32, which form the holding mechanism of the document reading unit 20 according to the first embodiment. FIG. 3 shows a state in which the document reading unit 20 is released from the securing unit 3 and opened and held at a first position A1 with respect to the closed position A0, at which the document reading unit 20 is closed, as shown in FIGS. 1 and 2. FIG. 3 also shows a state in which the document reading unit 20 is further opened to a second position A2.

The dampers 31 and 32 are provided on the upper front side of the document placement table 25 of the body apparatus 10. In this case, the dampers 31 and 32 are provided at positions where the dampers 31 and 32 do not interfere with the placement surface 25a of the document placement table 25. Specifically, the dampers 31 and 32 are provided so as to be able to protrude upward at two right and left positions on the front side of the body apparatus 10, which is the side opposite the hinge 2.

Note that the dampers 31 and 32 may instead be provided on the lower front side of the document cover 24 of the document reading unit 20. In this case, the dampers 31 and 32 are provided at positions where the dampers 31 and 32 do not interfere with the document discharge tray 29. Specifically, the dampers 31 and 32 may be provided so as to be able to protrude downward at two positions at the right and left ends on the front side of the document cover 24 of the document reading unit 20, which is the side opposite the hinge 2.

In the following description, it is assumed that the dampers 31 and 32 are provided at the document placement table 25 of the body apparatus 10.

Each of the dampers 31 and 32 includes an elastic member (not shown) such as a spring, and is configured to be stretchable and contractible. The dampers 31 and 32 can each provide the effect of pushing the document reading unit 20 upward with the aid of the elastic member.

Front ends of the dampers 31 and 32 are movable upward and downward as the dampers 31 and 32 stretch and contract. The dampers 31 and 32 are stretchable and contractible in accordance with the closed state and the open state of the document cover 24.

When the document reading unit 20 is closed and therefore secured by the securing unit 3, the document reading unit 20 is located at the closed position A0, as described above with reference to FIGS. 1 and 2. The document cover 24 of the document reading unit 20 is located so as to cover the placement surface 25a of the document placement table 25 from above.

The dampers 31 and 32 (not shown in FIGS. 1 and 2) are pressed and therefore contracted by the document cover 24 of the document reading unit 20. At this point in time, the front ends of the dampers 31 and 32 retreat downward to the position flush with the placement surface 25a of the document placement table 25.

The securing unit 3 can thus be brought into the secured state, in which the dampers 31 and 32 is kept contracted.

On the other hand, when the document reading unit 20 is released from the securing unit 3, the elastic force of the elastic members stretches the dampers 31 and 32, as shown in FIG. 3. The front ends of the dampers 31 and 32 protrude beyond the placement surface 25a of the document placement table 25 and pushes the front side of the document cover 24 upward. The document reading unit 20 opens while pivoting counterclockwise around the hinge 2.

The securing unit 3 can thus release the secured state to bring the dampers 31 and 32 into the unsecured state, in which the dampers 31 and 32 are stretched. The securing unit 3 allows the state of the dampers 31 and 32 to switch between the secured state and the unsecured state.

Furthermore, the dampers 31 and 32 allow the document reading unit 20 to be independently held at the first position A1 with the aid of the elastic force of the elastic members.

As described above, the securing unit 3 allows the state of the dampers 31 and 32 to switch between the secured state, in which the dampers 31 and 32 are kept contracted, and the unsecured state, in which the secured state is released so that the dampers 31 and 32 are stretched.

The holding mechanism includes the dampers 31 and 32, as described above. The dampers 31 and 32 are provided on the front side of the document placement table 25 or on the front side of the document cover 24 of the document reading unit 20, and are stretchable and contractible in accordance with the closed state and the open state of the document cover 24.

The holding mechanism further includes the securing unit 3. The securing unit 3 allows the state of the dampers 31 and 32 to switch between the secured state, in which the dampers 31 and 32 are kept contracted, and the unsecured state, in which the secured state is released so that the dampers 31 and 32 are stretched.

Let a distance L be the spacing between the placement surface 25a of the document placement table 25 and the front side of the document cover 24 of the document reading unit 20 at the first position A1, where the document cover 24 of the document reading unit 20 in the open state is located. The distance L preferably falls within a range longer than or equal to 3 cm but shorter than or equal to 10 cm.

In other words, at the first position A1, the dampers 31 and 32 can hold the document reading unit 20 in such a way that the distance L, which is the spacing between the placement surface 25a in the state in which the document cover 24 is open and the front side of the document cover 24, is longer than or equal to 3 cm but shorter than or equal to 10 cm. Note that the distance L is also the dimension by which the dampers 31 and 32 stretch.

Furthermore, let an angle θ be an angle between the placement surface 25a and the document cover 24, which are coupled to each other at the hinge 2, at the first position A1, where the document cover 24 is open. The angle θ preferably falls within a range greater than or equal to 5° but smaller than or equal to 20°.

In other words, at the first position A1, the dampers 31 and 32 can hold the document reading unit 20 in such a way that the angle θ, which is the angle between the placement surface 25a in the state in which the document cover 24 is open and the document cover 24, is greater than or equal to 5° but smaller than or equal to 20°.

The image recording apparatus 1 may be installed under a shelf, a desk, or the like where the space above the image recording apparatus 1 is limited. In such a situation, when the operator attempts to place the document M on the document placement table 25 of the document reader 20a, the document reading unit 20 may not be sufficiently opened.

The operator therefore opens the document reading unit 20 within a limited range. In this process, when the document reading unit 20 is not held, the document reading unit 20 undesirably closes due to its own weight. The operator needs to place the document M on the document placement table 25 with one hand while supporting the document reading unit 20 with the other hand, result in poor user-friendliness.

The dampers 31 and 32 can hold the document reading unit 20 at the first position A1, as described above. At this point in time, the dampers 31 and 32 can hold the document reading unit 20 in such a way that the distance L, which is the spacing between the placement surface 25a and the front side of the document cover 24, is longer than or equal to 3 cm but shorter than or equal to 10 cm, or the angle θ between the placement surface 25a and the document cover 24 is greater than or equal to 5° but smaller than or equal to 20°.

As a result, the operator can insert his/her fingers into the space between the placement surface 25a and the document cover 24 from the front side of the document reading unit 20. Furthermore, the operator does not need to support the document reading unit 20 with one hand, and can place the document M at the document placement table 25 or perform other tasks with both hands.

That is, the document reading unit 20 is so held that a spacing large enough to allow the operator to easily place the document M is provided between the document cover 24 of the document reading unit 20 and the placement surface 25a of the document placement table 25, resulting in good user-friendliness.

As described above, even when the image recording apparatus 1 is installed at a location where the space above the image recording apparatus 1 is limited, the operator can open the document reading unit 20 and easily place the document M from the front in the space between the document cover 24 and the placement surface 25a.

The document cover 24 is provided with the illuminator 5, such as an LED, which illuminates the placement surface 25a so that the operator can easily see his/her hands. The illuminator 5 can illuminate the placement surface 25a with the document cover 24 of the document reading unit 20 opened.

Note that the placement surface 25a may be illuminated with an LED provided in the first reader 21 of the document reading unit 20 or the second reader 22 of the document reader 20a in place of the illuminator 5. In the latter case, it is preferable that the document reader 20a is so configured that the mover 23 moves the LED of the second reader 22 to the center of the placement surface 25a before the LED illuminates the placement surface 25a.

After placing the document M on the placement surface 25a, the operator closes the document reading unit 20 and secures the document reading unit 20 with the securing unit 3. The document reading unit 20 is located at the closed position A0, as shown in FIGS. 1 and 2. The document M can be read by the document reader 20a of the body apparatus 10.

When the space above the image recording apparatus 1 is not limited, the document reading unit 20 can be opened to the second position A2, and can be held at the second position A2 with the aid of the frictional force of the hinge 2. The spacing corresponding to the second position A2 is greater than the distance L, which is the dimension by which the dampers 31 and 32 stretch.

As described above, the document cover 24 can be held at the first position A1, where the document cover 24 of the document reading unit 20 is located in the open state, and the second position A2, where the document cover 24 is held with the spacing greater than the distance L, which is the dimension by which the dampers 31 and 32 stretch.

The dampers 31 and 32 can move the position of the document cover 24 between the first position A1, where the angle of the document cover 24 around the hinge 2 with respect to the placement surface 25a is smaller, and the second position A2, where the angle is larger.

As described above, the image recording apparatus 1 can be configured to have the function of a flatbed scanner, the function of a sheet feed scanner, and the recording function.

In this case, the body apparatus 10 of the image recording apparatus 1 has a configuration including the sheet feed tray 14, which is a medium housing that houses the medium P, the medium transporting rollers 16 and 17, which are each a medium feeder that feeds the housed medium P toward the recording unit 11, and the medium discharge tray 19, which is a medium discharger into which the medium P on which an image is recorded by the recording unit 11 is discharged.

The document reading unit 20 of the image recording apparatus 1 includes the document support table 26, which is a document support that supports the document M, the document transporting rollers 28, which form a document feeder that feeds the document M supported by the document support table 26, the first reader 21, which is a reading sensor that reads an image of the document M fed from the document transporting rollers 28, and the document discharge tray 29, which is a document discharger to which the document M the image on which has been read by the first reader 21 is discharged.

In this case, the document reading unit 20 and the document cover 24 are integrated with each other.

The input/output unit 4, which is an operation unit that accepts the operator's operation, is disposed on the front side of the body apparatus 10. The medium transporting rollers 16 and 17 in the body apparatus 10 transport the medium P in a direction from the front side of the body apparatus 10, which is provided with the input/output unit 4, toward the rear side of the body apparatus 10. The medium transporting rollers 16 and 17 discharge the medium P into the medium discharge tray 19 from the rear side toward the front side of the body apparatus 10.

The document transporting rollers 28 in the document reading unit 20 feed the document M from the front side toward the rear side of the document reading unit 20. The document transporting rollers 28 discharge the document M into the document discharge tray 29 from the rear side toward the front side of the document reading unit 20.

Since the operation of feeding and discharging the medium P, the operation of feeding and discharging the document M, and the operation of placing the document M at the placement surface 25a can be all performed on the side facing the front surface of the image recording apparatus 1, the operator readily performs his/her tasks in a user-friendly manner. Furthermore, the image recording apparatus 1 provides the operator with good operability even when the image recording apparatus 1 is installed at a location where the space above the image recording apparatus 1 is narrow.

### 3. Holding Mechanism According to Second Embodiment

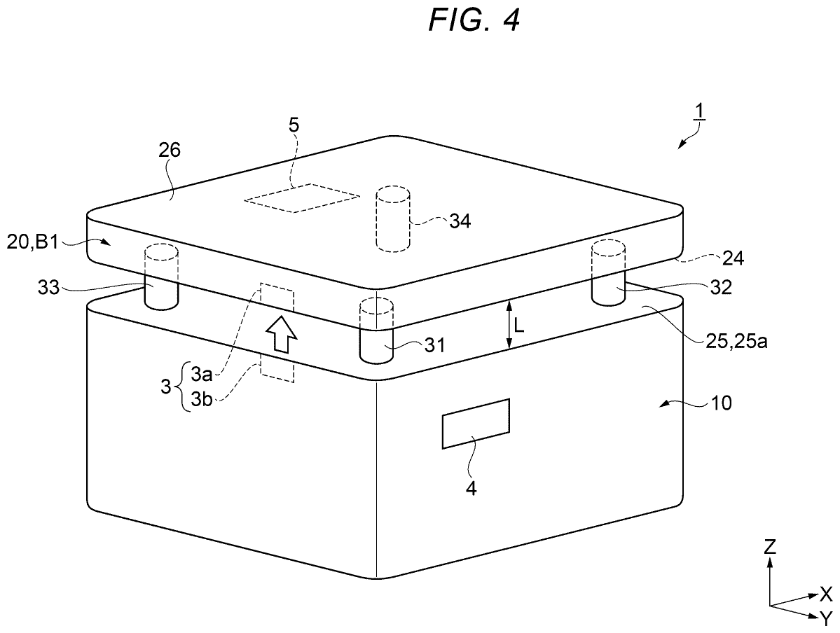

FIG. 4 shows dampers 31, 32, 33, and 34, which form the holding mechanism of the document reading unit 20 according to a second embodiment. FIG. 4 shows a state in which the document reading unit 20 is released from the securing unit 3, opened from the closed position B0, at which the document reading unit 20 is closed, as shown in FIGS. 1 and 2, and held at a first position B1.

The dampers 31, 32, 33, and 34 are provided at four corners on the upper side of the document placement table 25 of the body apparatus 10. The holding mechanism according to the second embodiment has a configuration in which the dampers 33 and 34 are added at two right and left positions on the rear side of the document placement table 25 to the dampers 31 and 32 in the first embodiment described above. The dampers 33 and 34 are also provided at positions where the dampers 33 and 34 do not interfere with the placement surface 25a of the document placement table 25.

Note that the dampers 31, 32, 33, and 34 may instead be provided at four corners on the lower side of the document cover 24 of the document reading unit 20. In this case, the dampers 31, 32, 33, and 34 are provided at positions where the dampers 31, 32, 33, and 34 do not interfere with the document discharge tray 29.

It is assumed in the following description that the dampers 31, 32, 33, and 34 are provided at the document placement table 25 of the body apparatus 10. The dampers 33 and 34 is configured in the same manner as the elastic-member-based dampers 31 and 32 described above, and will therefore not be described.

When the document reading unit 20 is closed and secured by the securing unit 3, the document reading unit 20 is located at the closed position B0, as shown in FIGS. 1 and 2. The document cover 24 of the document reading unit 20 is located so as to cover the placement surface 25a of the document placement table 25 from above.

The dampers 31, 32, 33, and 34 (not shown in FIGS. 1 and 2) are pressed and therefore contracted by the document cover 24 of the document reading unit 20. At this point in time, the front ends of the dampers 31, 32, 33, and 34 retreat downward to the position flush with the placement surface 25a of the document placement table 25.

On the other hand, when the document reading unit 20 is released from the securing unit 3, the elastic force of the elastic members stretches the dampers 31, 32, 33, and 34, as shown in FIG. 4. The front ends of the dampers 31, 32, 33, and 34 protrude beyond the placement surface 25a of the document placement table 25 and pushes the document cover 24 upward.

The document reading unit 20 ascends while maintaining the posture thereof parallel to the document placement table 25 of the body apparatus 10. Furthermore, the dampers 31, 32, 33, and 34 allow the document reading unit 20 to be independently held at the first position B1 with the aid of the elastic force of the elastic members with the posture of the document reading unit 20 being parallel to the document placement table 25.

As described above, the securing unit 3 allows the state of the dampers 31, 32, 33, and 34 to switch between a secured state in which the dampers 31, 32, 33, and 34 are kept contracted and an unsecured state in which the secured state is released so that the dampers 31, 32, 33, and 34 are stretched.

The holding mechanism includes the dampers 31, 32, 33, and 34, as described above. The dampers 31, 32, 33, and 34 are provided on the front and rear sides of the document placement table 25 or on the front and rear sides of the document cover 24 of the document reading unit 20, and can stretch and contract in accordance with the closed state and the open state of the document cover 24.

The holding mechanism further includes the securing unit 3. The securing unit 3 allows the state of the dampers 31, 32, 33, and 34 to switch between the secured state, in which the dampers 31, 32, 33, and 34 are kept contracted, and the unsecured state, in which the secured state is released so that the dampers 31, 32, 33, and 34 are stretched.

At the first position B1, where the document cover 24 of the document reading unit 20 is open, the distance L, which is the spacing between the placement surface 25a of the document placement table 25 and the document cover 24, preferably falls within the range longer than or equal to 3 cm but shorter than or equal to 10 cm.

In other words, at the first position B1, the dampers 31, 32, 33, and 34 can hold the document reading unit 20 in such a way that the distance L, which is the spacing between the placement surface 25a in the state in which the document cover 24 is open and the document cover 24, is longer than or equal to 3 cm but shorter than or equal to 10 cm.

As a result, the operator can insert his/her fingers into the space between the placement surface 25a and the document cover 24, which is the space sandwiched between the parallel surfaces, from the front or rear side of the document reading unit 20, so that the operator can easily perform tasks with his/her both hands.

As described above, even when the space above the image recording apparatus 1 is limited, the operator can open the document reading unit 20 and easily place the document M from the front or rear side in the space between the document cover 24 and the placement surface 25a.

The document cover 24 is provided with the illuminator 5, such as an LED, which illuminates the placement surface 25a.

When the operator places the document M at the placement surface 25a, then closes the document reading unit 20 to secure the document reading unit 20 with the securing unit 3, the document reading unit 20 is located at the closed position B0, as shown in FIGS. 1 and 2. The document reader 20a of the body apparatus 10 can read the document M.

Note in the second embodiment that the hinge 2 shown in FIGS. 1 and 2 is not provided, and that the document reading unit 20 is not opened to a position corresponding to the second position A2, unlike in the first embodiment.

### 4. Holding Mechanism According to Third Embodiment

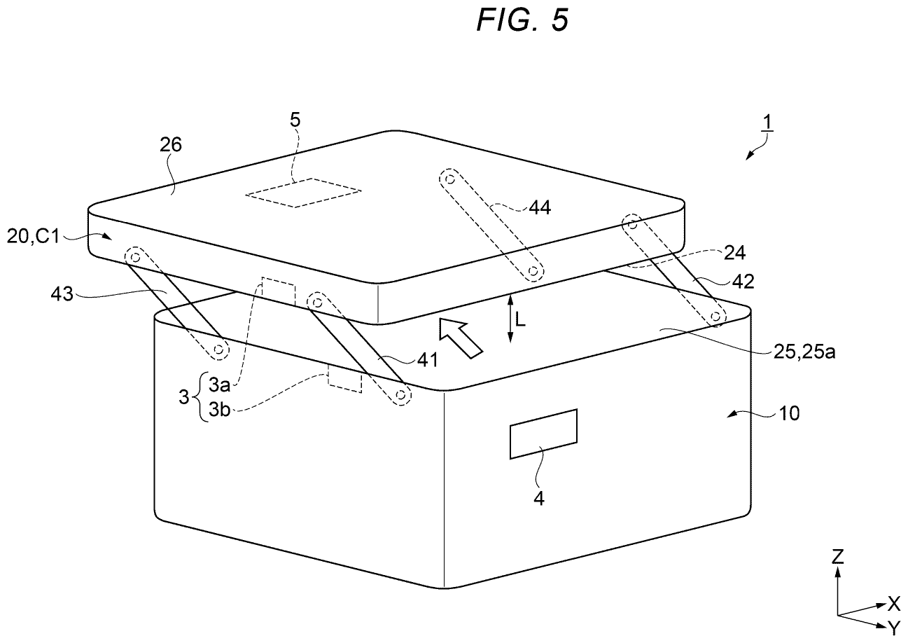

FIG. 5 shows links 41, 42, 43, and 44, which are each a link member and form a holding mechanism of the document reading unit 20 according to a third embodiment. FIG. 5 shows a state in which the document reading unit 20 is released from the securing unit 3, opened from the closed position C0, at which the document reading unit 20 is closed, as shown in FIGS. 1 and 2, and held at a first position Cl.

The links 41, 42, 43, and 44 are provided at front and rear positions on the right and left end surfaces of the document reading unit 20 and the body apparatus 10. The links 41, 42, 43, and 44 are provided at positions where the links 41, 42, 43, and 44 do not interfere with the placement surface 25a of the document placement table 25 and the document discharge tray 29 of the body apparatus 10.

The links 41, 42, 43, and 44 each have one end pivotably attached to a shaft provided in the document reading unit 20, and another end pivotably attached to a shaft provided in the body apparatus 10.

The links 41, 42, 43, and 44 each have an elastic member (not shown) such as a spring that attempts to pivot the one end counterclockwise around the other end. The links 41, 42, 43, and 44 each provide the effect of translating the document reading unit 20 upward and rearward with the aid of the elastic member.

When the document reading unit 20 is closed and secured by the securing unit 3, the document reading unit 20 is located at the closed position C0, as shown in FIGS. 1 and 2. The document cover 24 of the document reading unit 20 is located so as to cover the placement surface 25a of the document placement table 25 from above.

The links 41, 42, 43, and 44 (not shown in FIGS. 1 and 2) are housed in the document reading unit 20 and the body apparatus 10.

When the document reading unit 20 is released from the securing unit 3, the links 41, 42, 43, and 44 get out of the document reading unit 20 and the body apparatus 10 with the aid of the elastic force of the elastic members, as shown in FIG. 5. Furthermore, the links 41, 42, 43, and 44 can translate the document reading unit 20 upward and rearward to open the document reading unit 20.

At this point in time, the document reading unit 20 ascends while maintaining the posture thereof parallel to the document placement table 25 of the body apparatus 10. Furthermore, the links 41, 42, 43, and 44 allow the document reading unit 20 to be held at the first position Cl with the aid of the elastic force of the elastic members with the posture of the document reading unit 20 being parallel to the document placement table 25.

The securing unit 3 allows the state of the links 41, 42, 43, and 44 to switch between a secured state in which the links 41, 42, 43, and 44 are housed in and held by the document reading unit 20 and the body apparatus 10 and an unsecured state in which the secured state is released so that the links 41, 42, 43, and 44 are translated.

The holding mechanism includes the links 41, 42, 43, and 44, which are each a link member, as described above. The links 41, 42, 43, and 44 couple the document placement table 25 to the document cover 24 of the document reading unit 20, can move the document cover 24 from the front side toward the rear side of the document placement table 25 while moving the document cover 24 upward with respect to the document placement table 25 to switch the state of the document cover 24 from the closed state to the open state.

At the first position Cl, where the document cover 24 of the document reading unit 20 is open, the distance L, which is the spacing between the placement surface 25a of the document placement table 25 and the document cover 24, preferably falls within the range longer than or equal to 3 cm but shorter than or equal to 10 cm.

In other words, at the first position Cl, the links 41, 42, 43, and 44 can hold the document reading unit 20 with the aid of the elastic force of the elastic members in such a way that the distance L, which is the spacing between the placement surface 25a in the state in which the document cover 24 is open and the document cover 24, is longer than or equal to 3 cm but shorter than or equal to 10 cm.

As a result, the operator can insert his/her fingers into the space between the placement surface 25a and the document cover 24, which is the space sandwiched between the parallel surfaces, from the front or rear side of the document reading unit 20, so that the operator can easily perform tasks with his/her both hands.

As described above, even when the space above the image recording apparatus 1 is limited, the operator can open the document reading unit 20 and easily place the document M from the front or rear side in the space between the document cover 24 and the placement surface 25a.

The document cover 24 is provided with the illuminator 5, such as an LED, which illuminates the placement surface 25a.

When the operator places the document M at the placement surface 25a, then closes the document reading unit 20 to secure the document reading unit 20 with the securing unit 3, the document reading unit 20 is located at the closed position C0, as shown in FIGS. 1 and 2. The document reader 20a of the body apparatus 10 can read the document M.

Note in the third embodiment that the hinge 2 shown in FIGS. 1 and 2 is not provided, and that the document reading unit 20 is not opened to a position corresponding to the second position A2 in the first embodiment.

### 5. Holding Mechanism According to Fourth Embodiment

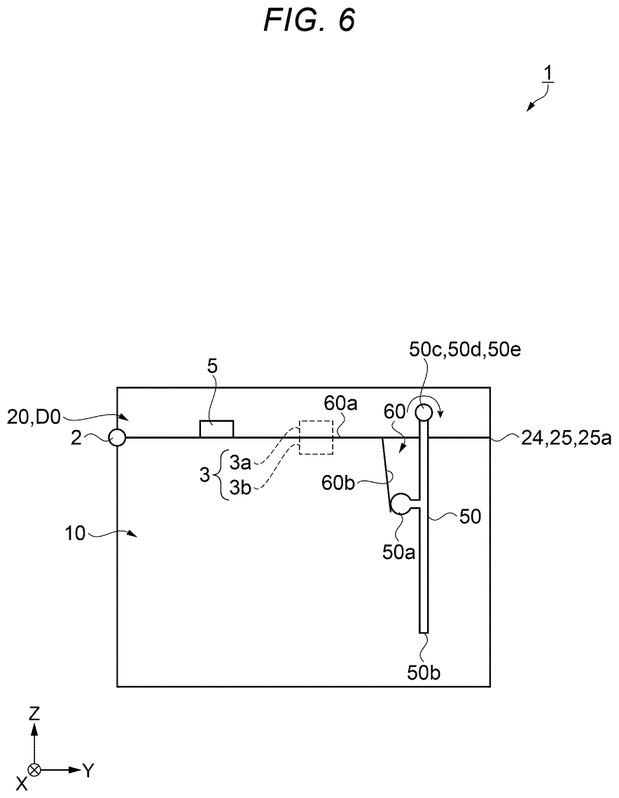

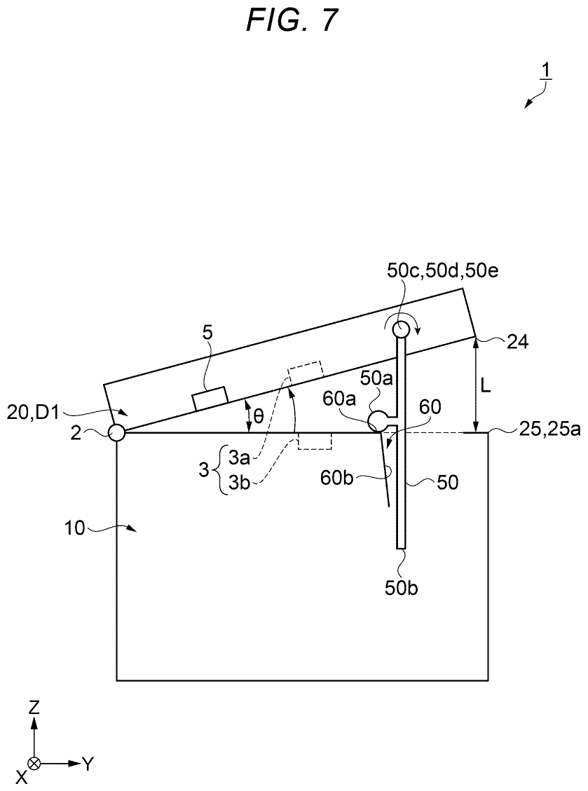

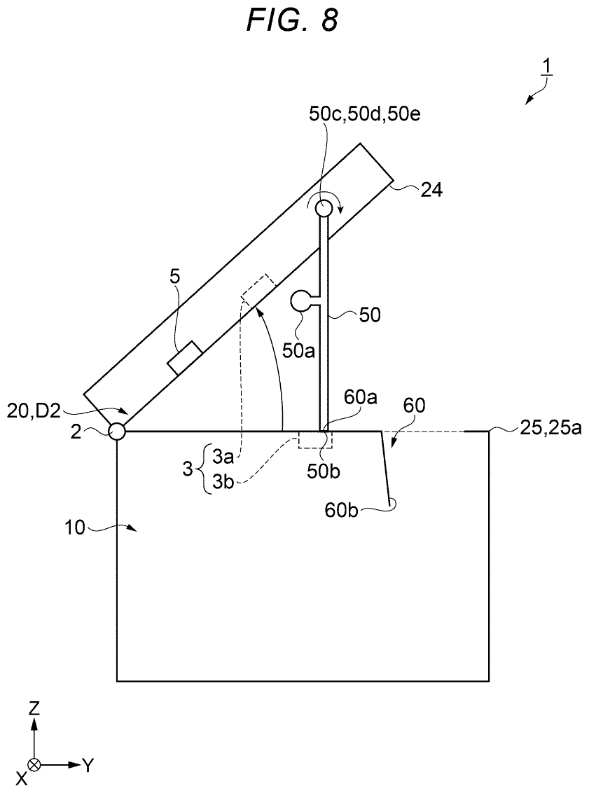

FIGS. 6 to 8 show a holder 50 and a guide 60, which form the holding mechanism of the document reading unit 20 according to a fourth embodiment. With respect to a closed position D0 shown in FIG. 6, in which the document reading unit 20 is closed, FIG. 7 shows a state in which the document reading unit 20 is released from the securing unit 3 and opened and held at a first position D1, and FIG. 8 shows a state in which the document reading unit 20 is further opened and held at a second position D2.

The holder 50 is a plate-shaped member and is provided at the document cover 24 of the document reading unit 20, as shown in FIGS. 6 to 8. The holder 50 is provided at a position where the holder 50 does not interfere with the placement surface 25a of the document placement table 25 and the document discharge tray 29 of the body apparatus 10.

The holder 50 has a protrusion 50a, which is located between one end 50b, which is the lower end, and another end 50c, which is the upper end, and protrudes rearward. The protrusion 50a is also referred to as what is called a dowel.

The holding mechanism also includes a shaft 50d disposed at the document cover 24 of the document reading unit 20. The other end 50c of the holder 50 is supported by the shaft 50d. An elastic member 50e such as a helical torsion spring is attached to the shaft 50d. The elastic member 50e attached to the shaft 50d causes torque to act on the holder 50, the torque causing the one end 50b to pivot clockwise around the other end 50c. The holder 50 can pivot and move as the document reading unit 20 is opened and closed.

As described above, the holder 50 is a plate-shaped member extending toward the document placement table 25. The one end 50b of the holder 50 is pivotable around the shaft 50d, and the protrusion 50a is provided in the middle of the holder 50 in an extending direction thereof.

The guide 60, which guides the moving holder 50, is formed in the body apparatus 10. The guide 60 has an inclining surface 60b and a stopper 60a. The stopper 60a is formed in the form of a surface flush with the placement surface 25a of the document placement table 25, a slightly recessed recess, or a step. The guide 60 is provided at a position where the guide 60 does not interfere with the placement surface 25a of the document placement table 25 and the document discharge tray 29 of the body apparatus 10.

As described above, the guide 60 is provided as part of the document placement table 25 of the body apparatus 10, and has the inclining surface 60b, which is an insertion portion which guides the holder 50 and into which the holder 50 can be inserted. The guide 60 includes the stopper 60a, which is a protruding support capable of supporting the protrusion 50a in the state in which the document cover 24 is open.

When the document reading unit 20 is closed and secured by the securing unit 3, the document reading unit 20 is located at the closed position D0, as shown in FIG. 6. The document cover 24 of the document reading unit 20 is located so as to cover the placement surface 25a of the document placement table 25 from above.

At this point in time, the holder 50 is housed in the guide 60 of the body apparatus 10. The protrusion 50a of the holder 50 is located so as to be in contact with the inclining surface 60b of the guide 60. The inclining surface 60b of the guide 60 is a surface inclining from the lower front side toward the upper rear side.

It is now assumed that the operator releases the document reading unit 20 from the securing unit 3 and opens the document reading unit 20. The document reading unit 20 pivots around the hinge 2, and the holder 50 attached to the document reading unit 20 also moves while pivoting, as shown in FIG. 7.

At this point in time, the protrusion 50a of the holder 50 moves upward and rearward along the inclining surface 60b of the guide 60 while being pushed rearward by the elastic member 50e. When the protrusion 50a climbs over the inclining surface 60b, the protrusion 50a engages with the stopper 60a. As a result, the document reading unit 20 can be independently held at the first position D1.

As described above, the securing unit 3 allows the state of the guide 60 to switch between a secured state in which the holder 50 is kept housed in the guide 60 and an unsecured state in which the secured state is released so that the protrusion 50a of the holder 50 engages with the stopper 60a.

When the document reading unit 20 is held at the first position D1, the spacing between the front side of the document cover 24 of the document reading unit 20 and the placement surface 25a of the document placement table 25 becomes the distance L. At the first position D1, the holder 50 can hold the document reading unit 20 in such a way that the distance L, which is the spacing between the placement surface 25a in the state in which the document cover 24 is open and the front side of the document cover 24, is longer than or equal to 3 cm but shorter than or equal to 10 cm.

Furthermore, at the first position D1, the holder 50 can hold the document reading unit 20 in such a way that the angle θ, which is the angle between the placement surface 25a in the state in which the document cover 24 is open and the document cover 24, is greater than or equal to 5° but smaller than or equal to 20°.

Even when the space above the image recording apparatus 1 is limited, the operator can open the document reading unit 20 and easily place the document M from the front side in the space between the document cover 24 and the placement surface 25a.

The document cover 24 is provided with the illuminator 5, such as an LED, which illuminates the placement surface 25a.

When the operator places the document M at the placement surface 25a, then closes the document reading unit 20 to secure the document reading unit 20 with the securing unit 3, the document reading unit 20 is located at the closed position D0, as shown in FIG. 6.

At this point in time, the operator grips the holder 50 and moves the holder 50 forward. The protrusion 50a of the holder 50 disengages from the stopper 60a. As the document reading unit 20 is closed, the protrusion 50a moves downward and forward along the inclining surface 60b of the guide 60, and the holder 50 is housed in the guide 60.

When the document reading unit 20 is closed, the document reader 20a of the body apparatus 10 can read the document M.

When the space above the image recording apparatus 1 is not limited, the operator can further open the document reading unit 20 from the first position D1, as shown in FIG. 8. The document reading unit 20 can be opened to the second position D2.

At this point in time, the one end 50b of the holder 50 climbs over the inclining surface 60b, engages with the stopper 60a, and stops. As a result, the document reading unit 20 is held at the second position D2.

As described above, the document cover 24 of the document reading unit 20 can be held at the first position D1, where the document cover 24 is located in the open state, and the second position D2, where the one end 50b of the holder 50 is supported by the stopper 60a.

The second position D2 is a position where the spacing between the placement surface 25a and the document cover 24 is greater than the distance L, which is the spacing between the placement surface 25a and the document cover 24 at the first position D1.

Note that the holder 50 may include multiple protrusions 50a between the one end 50b and the other end 50c. The spacing between the front side of the document cover 24 of the document reading unit 20 and the placement surface 25a of the document placement table 25 can thus be divided into multiple different spacings.

According to the embodiment described above, the image recording apparatus 1 includes the recording unit 11, which records an image on the medium P, the body apparatus 10, which houses the recording unit 11, and the document reader 20a, which is disposed in the upper portion of the body apparatus 10 and has the placement surface 25a, on which the document M is placed. The image recording apparatus 1 further includes the document cover 24, the state of which can be switched between the closed state in which the document cover 24 covers the placement surface 25a from above and the open state in which the space above the placement surface 25a is open, and the holding mechanism capable of holding the document reading unit 20 in such a way that the spacing between the placement surface 25a and the document cover 24 in the open state is greater than or equal to 3 cm but smaller than or equal to 10 cm.

Note that the image recording apparatus 1 according to the present embodiment may have a configuration in which the securing unit 3 is omitted. In this case, the document reading unit 20 can be closed by its own weight.

In the example described above, the holding mechanism is configured with the dampers 31 and 32 according to the first embodiment, the dampers 31, 32, 33, and 34 according to the second embodiment, the links 41, 42, 43, and 44 according to the third embodiment, or the holder 50 and the guide 60 according to the fourth embodiment.

The configuration described above allows the operator to insert his/her fingers into the space between the placement surface 25a and the document cover 24. Furthermore, the operator does not need to support the document reading unit 20 with one hand, and can place the document M at the document placement table 25 or perform other tasks with both hands. A user-friendly image recording apparatus 1 can thus be provided.

The embodiments have been described in detail with reference to the drawings, but the specific configuration of the image recording apparatus 1 is not limited to those in the embodiments, and changes, replacements, deletions, or other modifications may be made thereto without departing from the key points of the disclosure.

For example, the recording unit 11 may be a linear head that is not moved by the carriage 12, or may be an electrophotographic recording unit.

What is claimed is:

1. An image recording apparatus comprising:
a recording unit configured to record an image on a medium;
a body apparatus configured to house the recording unit;
a document reader disposed in an upper portion of the body apparatus and having a placement surface of a document placement table at which a document is placed;
a document cover a state thereof is allowed to be switched between a closed state in which the document cover covers the placement surface from above and an open state in which the document cover is opened to expose a space above the placement surface; and
a holding mechanism configured to hold the document cover in such a way that a spacing between the placement surface and the document cover in the open state is greater than or equal to 3 cm but smaller than or equal to 10 cm.

2. The image recording apparatus according to claim 1,
further comprising a hinge configured to link a far-side end of the document placement table to a far-side end of the document cover,
wherein the holding mechanism includes an elastic member provided on a front side of the document placement table or on a front side of the document cover and configured to stretch to produce the open state and contract to produce the closed state.

3. The image recording apparatus according to claim 2, wherein
the holding mechanism includes
a damper including the elastic member; and
a securing unit configured to switch a state of the damper between a secured state in which the damper is kept contracted and an unsecured state in which the secured state is released so that the damper is stretched.

4. The image recording apparatus according to claim 3, wherein
the document cover is configured to be held at
a first position where the document cover is located in the open state, and
a second position where the document cover is held with a spacing greater than a dimension by which the damper is stretched.

5. The image recording apparatus according to claim 1,
further comprising a hinge configured to link a far-side end of the document placement table to a far-side end of the document cover,
wherein the holding mechanism includes
a plate-shaped member having one end pivotable around a shaft disposed in the document cover and configured to support an another end the plate-shaped member, the plate-shaped member extending toward the document placement table,
a protrusion provided in a middle of the plate-shaped member in an extending direction thereof,
an insertion portion provided in the document placement table and into which the plate-shaped member is allowed to be inserted, and
a protrusion support provided at the document placement table and configured to support the protrusion in the open state.

6. The image recording apparatus according to claim 5, wherein
the document cover is allowed to be held at
a first position where the document cover is located in the open state, and
a second position where the one end of the plate-shaped member is supported by the protrusion support and the document cover is held with a spacing greater than a distance between the placement surface and the document cover at the first position.

7. The image recording apparatus according to claim 1, wherein
the holding mechanism includes
elastic members provided on a front side and a rear side of the document placement table or on a front side and a rear side of the document cover and configured to stretch to produce the open state and contract to produce the closed state.

8. The image recording apparatus according to claim 7, wherein
the holding mechanism includes
dampers including the elastic members; and
a securing unit configured to switch a state of the dampers between a secured state in which the dampers are kept contracted and an unsecured state in which the secured state is released so that the dampers are stretched.

9. The image recording apparatus according to claim 1, wherein
the holding mechanism includes
a link member configured to couple the document placement table to the document cover and move the document cover from a front side to a rear side of the document placement table relative to the document placement table to switch the state of the document cover from the closed state to the open state.

10. The image recording apparatus according to claim 1, further comprising a document reading unit,
wherein the body apparatus includes
a medium housing configured to house the medium, a medium feeder configured to feed the housed medium toward the recording unit, and a medium discharger configured to discharge the medium on which an image is recorded by the recording unit,
the document reading unit includes a document support configured to support the document, a document feeder configured to feed the document supported by the document support, a reading sensor unit configured to read an image of the document fed from the document feeder, and a document discharger configured to discharge the document the image of which is read by the reading sensor,
the document reading unit and the document cover are integrated with each other,
the image recording apparatus includes an operation unit disposed on a front side of the body apparatus and configured to accept an operation,
the medium feeder is configured to transport the medium in a direction from the front side of the body apparatus, where the operation unit is provided, toward a rear side of the body apparatus,
the medium is discharged from the rear side to the front side of the body apparatus to the medium discharger,
the document feeder is configured to feed the document from a front side toward a rear side of the document reading unit, and
the document is discharged from the rear side toward the front side of the document reading unit to the document discharger.

11. The image recording apparatus according to claim 1,
further comprising an illuminator configured to illuminate the placement surface in the open state of the document cover.
